(19) United States
(12) Patent Application Publication
(10) Pub. No.: US 2005/0264746 A1
(43) Pub. Date: Dec. 1, 2005

(54) Liquid crystal display with metal electrodes

(75) Inventor: Ren-Hao Ou, Taipei (TW)

Correspondence Address: MICHAEL W. TAYLOR, P.O. BOX 3791, ORLANDO, FL, 32802-3791, US

(73) Assignee: Arima Display Corp., Taipei (TW)

(21) Appl. No.: 10/853,984

(22) Filed: May 26, 2004

(51) Int. Cl. G02F 1/1345

(52) U.S. Cl. 349/149

(57) ABSTRACT

A liquid crystal display with metal electrodes is provided. The liquid crystal display includes a first substrate, a plurality of metal electrode layers formed on the first substrate, a plurality of transparent electrode layers formed on the metal electrode layers, and a second substrate coupled to the first substrate with a seal.

### FIELD OF THE INVENTION

The present invention relates to a liquid crystal display, and more particularly to a liquid crystal display with metal electrodes.

### BACKGROUND OF THE INVENTION

The working principle of the liquid crystal display (LCD) is to control the path of a light source which can be cold cathode fluorescent lamps and light emitting diodes inside the liquid crystal display or the sunlight and the indoor light outside the liquid crystal display. Therefore, the liquid crystal display can be divided into three types, the transmissive one, the reflective one and the transflective one. The transmissive liquid crystal display is not suitable for use in the environment with strong light, while the reflective liquid crystal display is not suitable for use in the environment with dim light. In comparison, the using environment of the transflective liquid crystal display is more flexible, and thus the transflective liquid crystal is suitable for use in any environment.

Please refer to FIG. 1, which shows a structural diagram of a transflective liquid crystal display according to the prior art. The liquid crystal display is assembled by an upper substrate 11 and a lower substrate 12. The lower substrate 12 includes a terminal portion 121 disposed at a lower part thereof, in which the terminal portion 121 includes a control IC 122 disposed thereon. The terminal portion 121 is exposed outside the liquid crystal display after the upper substrate 11 and the lower substrate 12 are assembled so as to connect with a flexible print circuit (FPC) (not shown). Traditionally, the lower substrate 12 is a transflective substrate. Moreover, a plurality of transparent electrodes 123 made of indium tin oxide (ITO) are formed on the lower substrate 12, and the lower substrate 12 is bonded to the upper substrate 11 with a seal 13, as shown in FIG. 2. However, the conventional liquid crystal display with transparent electrodes made of indium tin oxide will easily cause the problem of high impedance difference of layouts, which results in the noise that can influence the image quality.

From the above description, it is known that how to develop a new liquid crystal display with the advantage of reducing the impedance value has become a major problem waited to be solved. In order to overcome the drawbacks in the prior art, a liquid crystal display with metal electrodes is provided. The particular design in the present invention not only solves the problem described above, but also lowers the noise. Moreover, the liquid crystal display has a simple structure and is easy to realize. Thus, the invention has the utility for the industry.

### SUMMARY OF THE INVENTION

It is an object of the present invention to provide a novel liquid crystal display that utilizes the deposition of metal electrode layers to reduce the impedance value so as to lower the noise.

In accordance with one aspect of the present invention, a liquid crystal display with metal electrodes includes a first substrate, a plurality of metal electrode layers formed on the first substrate, a plurality of transparent electrode layers formed on the metal electrode layers, and a second substrate coupled to the first substrate with a seal.

Preferably, the first substrate includes a terminal portion disposed at a lower part thereof.

Preferably, the terminal portion includes a control IC disposed thereon, and the metal electrode layers are formed at a specific position away from a pin of the control IC.

Preferably, the metal electrode layers are formed at a specific position away from a plurality of pins of the control IC.

Preferably, the first substrate is a lower substrate.

Preferably, the lower substrate is a glass substrate.

Preferably, the metal electrode layers are made of an alloy of aluminum and neodymium.

Preferably, the transparent electrode layers are respectively formed on the metal electrode layers.

Preferably, the transparent electrode layers are made of indium tin oxide (ITO).

Preferably, the second substrate includes a plurality of black matrix layers and a plurality of color filter layers sequentially formed thereon.

Preferably, the second substrate is bonded to the first substrate with a seal.

Preferably, the second substrate is an upper substrate.

Preferably, the upper substrate is a glass substrate.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a structural diagram showing a transflective liquid crystal display according to the prior art;

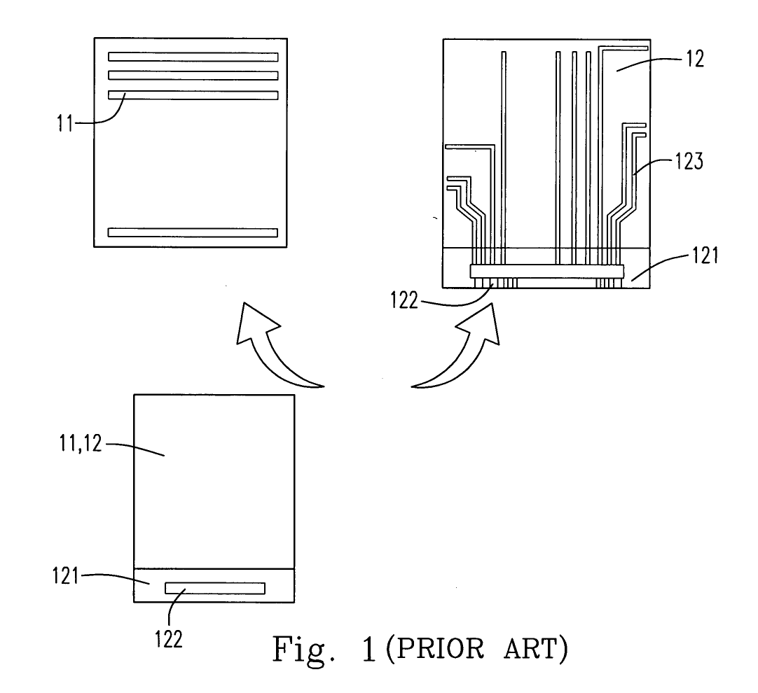

FIG. 2 is a cross-sectional view of FIG. 1;

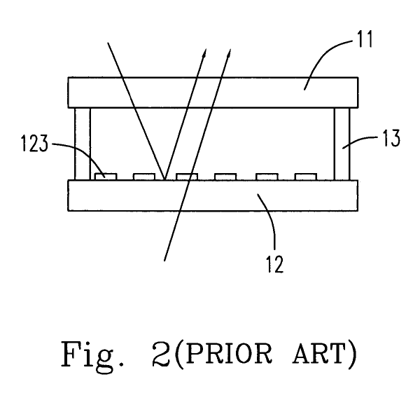

FIG. 3 is a structural diagram showing a liquid crystal display with metal electrodes according to a preferred embodiment of the present invention;

FIG. 4 is a cross-sectional view of FIG. 3;

FIG. 5 is a partial top view of FIG. 4;

FIG. 6 is a structural diagram showing a liquid crystal display with metal electrodes according to another preferred embodiment of the present invention;

FIG. 7 is a cross-sectional view of FIG. 6;

FIG. 8 is a partial top view of FIG. 7; and

FIG. 9 is a structural diagram showing a liquid crystal display with metal electrodes according to a further preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

In order to reduce the problem of high impedance difference of layouts, the present invention proposes a novel liquid crystal display that utilizes the deposition of metal electrode layers to reduce the impedance value so as to lower the noise. Because R=ρ*(l/A) (R: resistance, ρ: resistance coefficient, l: length, A: cross-sectional measure), the impedance value can be effectively reduced as long as the resistance coefficient value is reduced. Based on the above theory, the present invention employs the metal electrodes with low resistance coefficient in the liquid crystal display so as to reduce the impedance value and lower the noise.

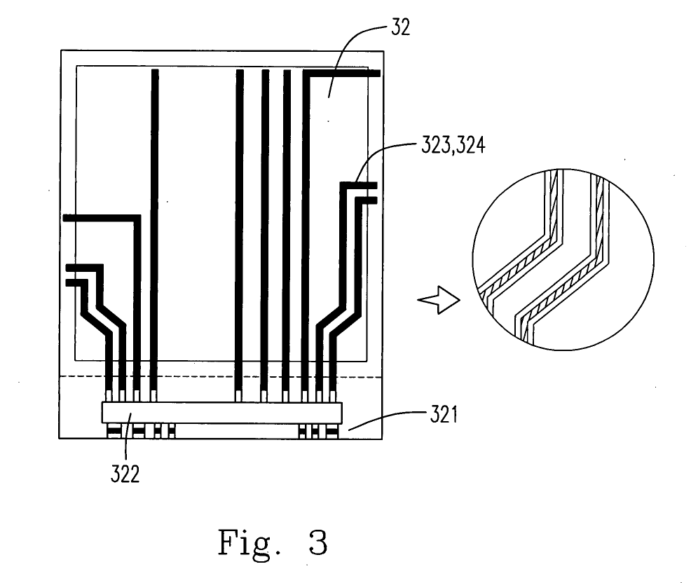

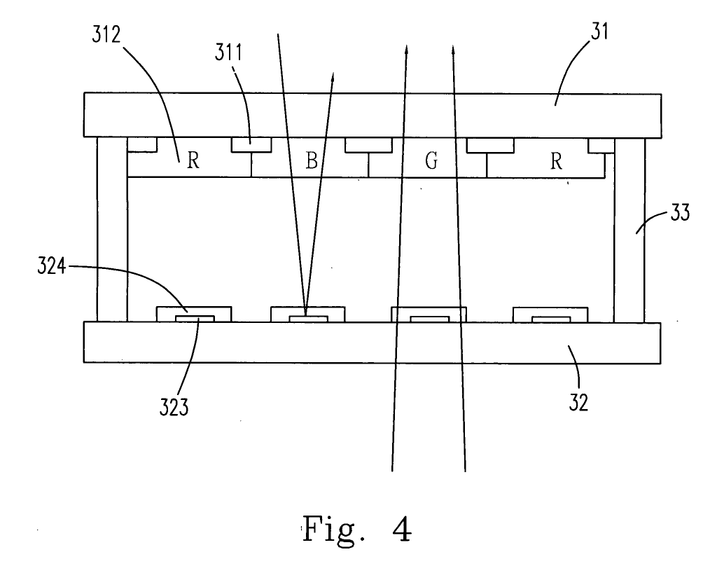

Please refer to FIG. 3 and FIG. 4, which respectively show a structural and a cross-sectional views of a liquid crystal display with metal electrodes according to a preferred embodiment of the present invention. The liquid crystal display includes an upper substrate 31 and a lower substrate 32. A plurality of metal electrode layers 323 are formed on the lower substrate 32 first (e.g. metal electrode layers made of the alloy of aluminum and neodymium), and then a plurality of transparent electrode layers 324 are respectively formed on the metal electrode layers 323 (e.g. transparent electrode layers made of indium tin oxide). Meanwhile, a plurality of black matrix layers 311 and a plurality of color filter layers 312 are sequentially formed on the upper substrate 31 that is bonded to the lower substrate 32 with a seal 33. Preferably, the upper substrate 31 and the lower substrate 32 are both glass substrates.

The lower substrate 32 includes a terminal portion 321 disposed at a lower part thereof, in which the terminal portion 321 includes a control IC 322 disposed thereon for controlling the operation of the liquid crystal display. In order to monitor the fracture state of the electricity-conductive particles on the anisotropic conductive film (ACF) used for adhering the control IC 322 to the lower substrate 32, the metal electrode layers 323 are formed at a specific position away from the plural pins of the control IC 322 so as to prevent the pins of control IC 322 from being covered by the metal electrode layers 323 and thereby the fracture state of the electricity-conductive particles is judged correctly. In which, the specific position is inside the terminal portion 321 and near the plural pins of the control IC 322. Because the incomplete fracture or excessive fracture of the electricity-conductive particles will lead to the problem of impedance difference between the control IC 322 and the circuit, the metal electrode layers of the present invention has no contact with the pins of the control IC 322 but are formed at a specific position away from the pins of the control IC 322 so as to achieve the optimum efficiency.

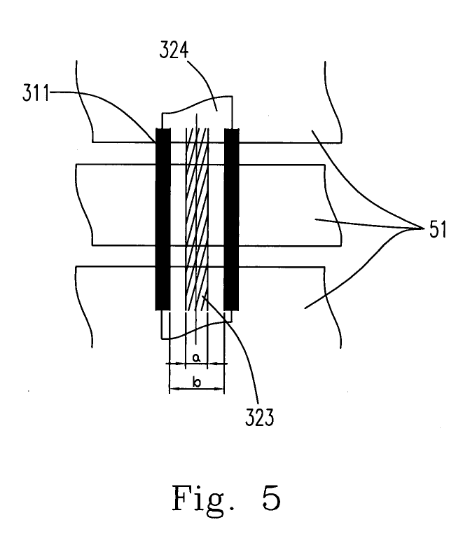

Please refer to FIG. 5, which shows a partial top view of FIG. 4. As shown in FIG. 5, the metal electrode layers 323 are positioned inside the transparent electrode layers 324 in the pixel unit 51, and thus an opening rate [(1−a/b)*100%] can be inferred therefrom as a judging basis of the reflective/transmissive efficiency. When the width of the metal electrode layer 323 is wider, the opening rate will be smaller and the reflective effect will be better. Contrarily, when the width of the metal electrode layer 323 is narrower, the opening rate will be larger and the transmissive effect will be better. In practice, the magnitude of the opening rate can be adjusted according to the practical demand so as to manufacture the products in demand and increase the flexibility for manufacture.

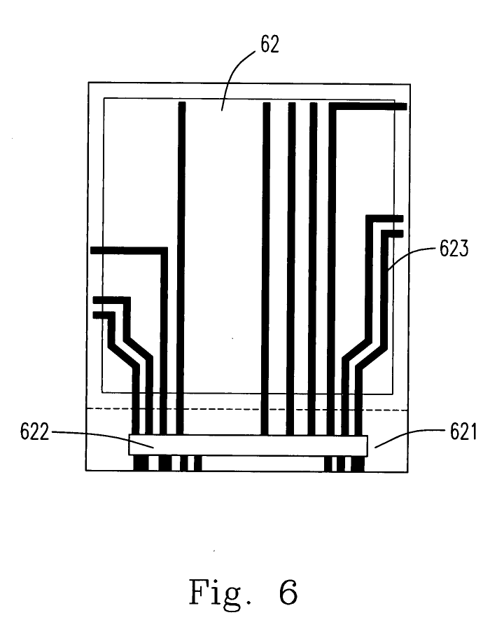

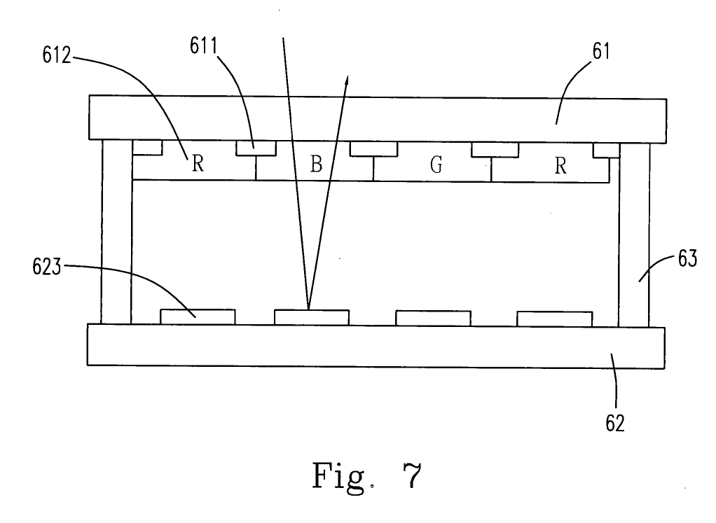

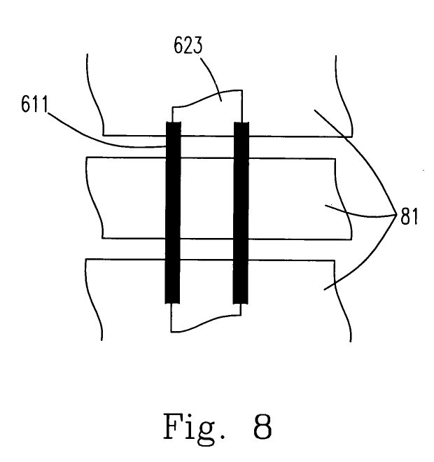

In order to be cooperative with the liquid crystal display having the total-internal-reflection structure, the conventional transparent electrode layers made of indium tin oxide are replaced with the metal electrode layers in another preferred embodiment of the present invention, as shown in FIG. 6 and FIG. 7. The liquid crystal display includes an upper substrate 61 and a lower substrate 62. A plurality of metal electrode layers 623 are formed on the lower substrate 62 (e.g. metal electrode layers made of the alloy of aluminum and neodymium). Meanwhile, a plurality of black matrix layers 611 and a plurality of color filter layers 612 are sequentially formed on the upper substrate 61 that is bonded to the lower substrate 62 with a seal 63. Preferably, the upper substrate 61 and the lower substrate 62 are both glass substrates. Similarly, the lower substrate 62 includes a terminal portion 621 disposed at a lower part thereof, in which the terminal portion 621 includes a control IC 622 disposed thereon for controlling the operation of the liquid crystal display. Please refer to FIG. 8, which shows a partial top view of FIG. 7. The configuration of the metal electrode layers 623 inside the pixel unit is shown in FIG. 8.

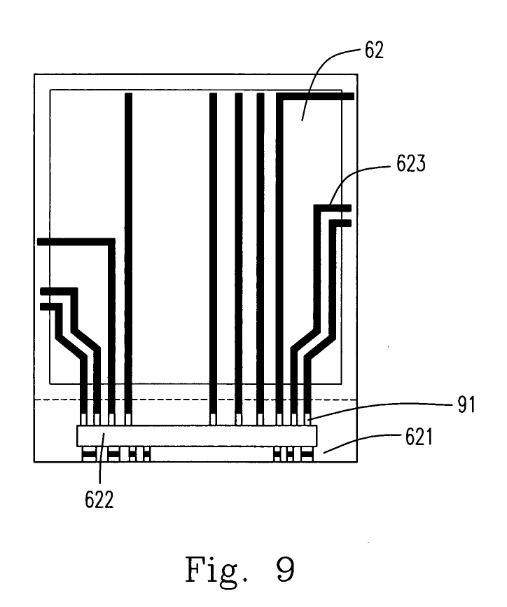

In order to monitor the fracture state of the electricity-conductive particles on the anisotropic conductive film (ACF) used for adhering the control IC 622 to the lower substrate 62, the metal electrode layers 623 are also formed at a specific position away from the plural pins of the control IC 622. In which, the specific position is inside the terminal portion 621 and near the plural pins of the control IC 622. A plurality of transparent electrode layers 91 (e.g. transparent electrode layers made of indium tin oxide) are formed from the specific position to the pins of the control IC 622 to replace the metal electrode layers 623, as shown in FIG. 9, so that the pins of the control IC 622 are prevented from being covered by the metal electrode layers 623 and thereby the fracture state of the electricity-conductive particles is judged correctly.

In view of the aforesaid description, the present invention proposes a novel liquid crystal display that utilizes the deposition of metal electrode layers to reduce the impedance value so as to lower the noise. Accordingly, the present invention can effectively solve the problems and drawbacks in the prior arts, and thus fits the demand of the industry and is industrially valuable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A liquid crystal display with metal electrodes, comprising:
a first substrate;
a plurality of metal electrode layers formed on said first substrate;
a plurality of transparent electrode layers formed on said metal electrode layers; and
a second substrate coupled to said first substrate with a seal.

2. The liquid crystal display as claimed in claim 1, wherein said first substrate comprises a terminal portion disposed at a lower part thereof.

3. The liquid crystal display as claimed in claim 2, wherein said terminal portion comprises a control IC disposed thereon, and said metal electrode layers are formed at a specific position away from a pin of said control IC.

4. The liquid crystal display as claimed in claim 3, wherein said metal electrode layers are formed at a specific position away from a plurality of pins of said control IC.

5. The liquid crystal display as claimed in claim 1, wherein said first substrate is a lower substrate.

6. The liquid crystal display as claimed in claim 5, wherein said lower substrate is a glass substrate.

7. The liquid crystal display as claimed in claim 1, wherein said metal electrode layers are made of an alloy of aluminum and neodymium.

8. The liquid crystal display as claimed in claim 1, wherein said transparent electrode layers are respectively formed on said metal electrode layers.

9. The liquid crystal display as claimed in claim 1, wherein said transparent electrode layers are made of indium tin oxide (ITO).

10. The liquid crystal display as claimed in claim 1, wherein said second substrate comprises a plurality of black matrix layers and a plurality of color filter layers sequentially formed thereon.

11. The liquid crystal display as claimed in claim 1, wherein said second substrate is bonded to said first substrate with a seal.

12. The liquid crystal display as claimed in claim 1, wherein said second substrate is an upper substrate.

13. The liquid crystal display as claimed in claim 12, wherein said upper substrate is a glass substrate.
